(19) United States
(12) Patent Application Publication
(10) Pub. No.: US 2023/0092470 A1
(43) Pub. Date: Mar. 23, 2023

(54) OIL SUPPLY STRUCTURE AND CLUTCH DEVICE

(71) Applicant: HONDA MOTOR CO., LTD., TOKYO (JP)

(72) Inventors: Hitoshi SAITO, TOKYO (JP); Koichi TANIGUCHI, TOKYO (JP)

(21) Appl. No.: 17/942,584

(22) Filed: Sep. 12, 2022

(30) Foreign Application Priority Data
Sep. 21, 2021 (JP) 2021-153680

(51) Int. Cl. F16D 25/0638; F16D 13/52

(52) U.S. Cl. CPC F16D 25/0638; F16D 13/52

(57) ABSTRACT

An oil supply structure of a clutch device includes a pressure plate facing a clutch center fixed to a shaft member on an inner side of a clutch outer relatively rotatable with respect to the shaft member, a clutch plate alternately fitted and inserted between the pressure plate and the clutch center, a clutch spring that biases the pressure plate toward the clutch center side, and a clutch lifter member provided to be relatively rotatable with respect to the pressure plate and including an insertion portion inserted into the shaft member, where a supply oil passage in which an opening area changes due to axial movement of the clutch lifter member accompanying switching of clutch connection/disconnection is formed in the clutch lifter member 60. The oil supply structure enables the supply of oil to the clutch device to be adjusted only according to the clutch operation.

### TECHNICAL FIELD

The present invention relates to an oil supply structure of a clutch device and a clutch device equipped with the same.

### BACKGROUND ART

Conventionally, in a motorcycle or the like, a clutch device is provided between an internal combustion engine serving as a power source and a transmission mechanism. Examples of the clutch device include a multi-plate clutch device including a plurality of friction plates and a plurality of clutch plates. When oil is excessively supplied to the clutch device, a drag torque is generated in the clutch plate subjected to a resistance force due to viscosity of the oil, that is, a frictional force. Patent Document 1 discloses an example of a configuration for reducing the drag torque. Patent Document 1 discloses a configuration including an oil control mechanism that requires various components such as a pair of governor weights, in which the oil supply to the clutch device is stopped when the motorcycle is stopped, the clutch is disconnected, and the rotation of the transmission mechanism is also stopped, and on the other hand, the oil of an amount corresponding to the rotation speed (rpm) of the transmission mechanism is supplied to the clutch when the clutch is in the connected state, the motorcycle starts traveling, and the rotation of the transmission mechanism is increased.

### PRIOR ART DOCUMENT

### Patent Document

Patent Document 1: JP 2015-94408 A

### SUMMARY OF THE INVENTION

### Underlying Problems to be Solved by the Invention

The configuration disclosed in Patent Document 1 requires an oil control mechanism having a complicated configuration and requiring many components, and the amount of oil supplied to the clutch device cannot be adjusted only in accordance with the clutch operation. An object of the present invention is to provide a simpler configuration that enables the supply of oil to the clutch device to be adjusted only according to the switching of the clutch connection/disconnection.

### Means to Solve the Problems

One aspect of the present invention provides

an oil supply structure of a clutch device including,

a clutch outer that is supported by a shaft member in a relatively rotatable manner;

a clutch center disposed on an inner side of the clutch outer and fixed to the shaft member;

a pressure plate facing the clutch center in an axial direction of the shaft member;

a friction plate and a clutch plate alternately fitted and inserted between the pressure plate and the clutch center;

a clutch spring that biases the pressure plate toward the clutch center side; and a clutch lifter member provided on the pressure plate in a relatively rotatable manner in a radially inner side of the pressure plate;

the clutch lifter member including an insertion portion and a support portion lined in the axial direction, the insertion portion being configured to be inserted into an axial oil passage of the shaft member, the support portion being configured to support the pressure plate, and the clutch lifter member being configured to be moved in the axial direction with switching of clutch connection/disconnection; where

a supply oil passage in which an opening area changes by movement of the clutch lifter member in the axial direction accompanying the switching of clutch connection/disconnection is formed in at least one of the shaft member and the clutch lifter member.

passage in which the opening area changes by the movement of the clutch lifter member in the axial direction accompanying the switching of the clutch

According to the above configuration, the supply oil connection/disconnection is formed in at least one of the shaft member and the clutch lifter member. Therefore, the supply of oil to the clutch device can be adjusted only according to the switching of the clutch connection/disconnection. According to the above configuration, the supply of oil to the clutch device can be adjusted with a simple configuration of including such a supply oil passage.

Preferably, the clutch lifter member includes the insertion portion, the support portion, and an engagement portion lined in the axial direction, where the engagement portion is configured so as to be engaged by an actuation member, and the clutch lifter member is provided so as to be moved in a direction away from the clutch center in the axial direction by the actuation member moved with clutch disconnection. With this configuration, the clutch lifter member can be relatively moved with respect to the shaft member in a direction away from the clutch center in the axial direction by the actuation member moved with the clutch disconnection.

Preferably, the supply oil passage is provided so that the opening area is larger when the clutch is disconnected than that when the clutch is connected. With this configuration, while maintaining the oil supply amount necessary at the time of clutch connection, the supply amount of oil can be increased from the start to the release at the time of clutch disconnection. Therefore, for example, clutch disconnection of when the clutch is disconnected from the clutch connection state can be maintained in a suitable state, and wear toughness of the clutch can be more suitably enhanced.

Preferably, the clutch lifter member includes an axial oil passage that opens toward the insertion portion side and closes on the engagement portion side, and the supply oil passage communicates with the axial oil passage of the clutch lifter member and is provided in the insertion portion of the clutch lifter member. With this configuration, the supply of oil to the inside of the clutch device can be more suitably adjusted with the movement of the clutch lifter member in the axial direction.

Preferably, the insertion portion of the clutch lifter member includes an inclined portion that approaches an axis line of the clutch lifter member as it moves away from the support portion. With this configuration, the oil supply amount from the periphery of the clutch lifter member at the time of the clutch connection or the half clutch can be increased as compared with when the inclined portion is not provided.

Preferably, the supply oil passage is provided in the shaft member, and is provided such that the amount of communication with the axial oil passage of the shaft member changes as the insertion portion of the clutch lifter member moves in the axial oil passage of the shaft member. With this configuration, the communication amount with the axial oil passage of the supply oil passage provided in the shaft member changes with the movement of the clutch lifter member, and for example, the supply oil passage can be opened or closed to the axial oil passage, and thus the oil supply amount to the clutch device can be suitably adjusted.

Preferably, the insertion portion of the clutch lifter member includes an inclined portion that approaches the axis line of the clutch lifter member as it moves away from the support portion, and the clutch lifter member is disposed on the shaft member such that the inclined portion is shifted from the supply oil passage. With this configuration, the oil supply amount from the periphery of the clutch lifter member at the time of the clutch connection can be increased as compared with when the inclined portion is not provided, but such supply amount can be prevented from becoming excessive.

The present invention also relates to a clutch device including the oil supply structure having the above configuration.

### Effects of the Invention

According to the above aspect of the present invention, since the above configuration is provided, the supply of oil to the clutch device can be adjusted only according to the switching of the clutch connection/disconnection with a simpler configuration.

### BRIEF DESCRIPTION OF DRAWINGS

FIG. 1 is a cross-sectional view of a clutch device and a periphery thereof according to a first embodiment of the present invention.

FIG. 2 is a view illustrating a mechanism of manual operation of the clutch device.

FIG. 3 is an enlarged view of the periphery of a clutch lifter member of the clutch device of FIG. 1, and is a view showing a part of the mechanism of FIG. 2 in an overlapping manner.

FIG. 4 is an enlarged view of the periphery of the clutch lifter member of the clutch device of FIG. 1, illustrating a state in which the clutch lifter member is moved in an axial direction with clutch disconnection in FIG. 3.

FIG. 5 is a cross-sectional view of a clutch device and a periphery thereof according to a second embodiment of the present invention.

FIG. 6 is an enlarged view of the periphery of a clutch lifter member of the clutch device of FIG. 5, and is a view showing a part of the mechanism of FIG. 2 in an overlapping manner.

FIG. 7 is an enlarged view of the periphery of the clutch lifter member of the clutch device of FIG. 5, illustrating a state in which the clutch lifter member is moved in an axial direction with clutch disconnection in FIG. 6.

FIG. 8 is a front view of a clutch lifter member of the clutch device of FIG. 5.

FIG. 9 is a bottom view of the clutch lifter member of FIG. 8.

### MODES FOR CARRYING OUT THE INVENTION

Hereinafter, embodiments according to the present invention will be described with reference to the accompanying drawings. A same numeral is given to a same component (or configuration), and a name and a function thereof are the same. Therefore, detailed description thereof will not be repeated.

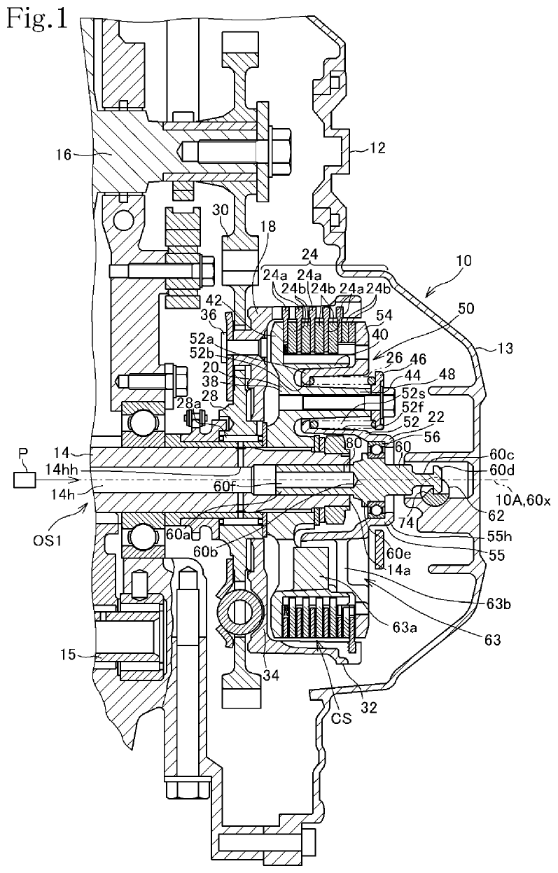

FIG. 1 shows a cross-sectional view of a clutch device 10 and a periphery thereof according to a first embodiment of the present invention. The clutch device 10 is provided between an engine and a transmission. The engine is mounted on a motorcycle and is a water-cooling type multi-cylinder four-stroke internal combustion engine, but is not limited to this type, and may be, for example, a single-cylinder four-stroke internal combustion engine. Note that the vehicle provided with the clutch device 10 may be a three-wheel vehicle including two front wheels or two rear wheels, and a vehicle including four or more wheels.

A crankshaft 16 of the engine is pivotally supported in a crankcase 12 directed in the left-right direction which is also the vehicle width direction of the vehicle. The crankcase 12 is connected to a clutch case 13 and the like, which form a crank chamber in which the crankshaft 16 is disposed, and form a transmission chamber that accommodates the transmission on the back side of the crank chamber.

The transmission includes a main shaft 14 and a counter shaft 15 that pivotally support a plurality of transmission gears that mesh with each other. The main shaft 14 is rotated when a driving force of the engine is transmitted via the clutch device 10. The main shaft 14 and the counter shaft 15 extend in parallel with the crankshaft 16 of the engine. The main shaft 14 is a shaft member in the present invention.

The clutch device 10 can arbitrarily connect and disconnect the transmission of the driving force from the crankshaft 16 side to the transmission. The clutch device 10 is provided on the main shaft 14 of the transmission.

The axial direction of the clutch device 10 coincides with the axial direction of the main shaft 14.

The clutch device 10 is a so-called multi-plate clutch device. The clutch device 10 includes a clutch outer 18 supported by the main shaft 14 in a relatively rotatable manner, a clutch center 20 disposed on the inner side of the clutch outer 18 and fixed to the main shaft 14, a pressure plate 22 facing the clutch center 20 in the axial direction of the clutch device 10, friction plates 24a and clutch plates 24b that can be alternately inserted and clamped between the pressure plate 22 and the clutch center 20, a clutch spring 26 that biases the pressure plate 22 toward the clutch center 20 side, and a clutch lifter member 60. Hereinafter, the friction plate 24a and the clutch plate 24b may be collectively referred to as a clutch plate 24.

An input member 28 to which the driving force of the engine is input is provided on the main shaft 14. The input member 28 is a gear that meshes with a primary drive gear 30 provided on the crankshaft 16 of the engine, and is a primary driven gear. The input member 28 is supported by the main shaft 14 in a relatively rotatable manner through a bearing 28a, which is a needle bearing here.

The clutch outer 18 includes an outer cylindrical portion 32 and a disc portion 34 provided to close one end of the outer cylindrical portion 32. As described above, the clutch outer 18 has a bottomed cylindrical shape. The disc portion 34 is formed such that the main shaft 14 penetrates the central portion thereof, and is supported by the main shaft 14 in a relatively rotatable manner. The clutch outer 18 is integrally fixed to the outer side surface of the input member 28 by a rivet 36 inserted into the disc portion 34. That is, when the driving force of the crankshaft 16 is transmitted to the input member 28, the clutch outer 18 rotates synchronously with the input member 28 on the main shaft 14. The outer cylindrical portion 32 extending in the axial direction from the outer peripheral edge of the disc portion 34 defines and forms, on the inner side, a space for accommodating the clutch center 20, the pressure plate 22, and the friction plates 24a and the clutch plates 24b alternately inserted therebetween.

The clutch center 20 includes a disc-shaped base portion 38 arranged to face the disc portion 34 of the clutch outer 18 with the central portion fixed to the main shaft 14, a center cylindrical portion 40 extending in a direction of an axis line 10A of the clutch device 10 from the base portion 38, that is, in the axial direction coaxially with the outer cylindrical portion 32 of the clutch outer 18, a flange-shaped pressure receiving portion 42 extending radially outward from the outer peripheral portion of the base portion 38, and a plurality of clutch center side boss portions 44 extending in the axial direction of the clutch device 10 from the base portion 38 on the inner side of the center cylindrical portion 40. The clutch center 20 has the limited relative rotation of the base portion 38 relative to the main shaft 14, and a central portion thereof pivotally supported, that is, fixed to the main shaft 14, and rotates synchronously with the main shaft 14. The clutch center 20 is fixed so as to be immovable in the axial direction of the main shaft 14, that is, in the axial direction of the clutch device 10.

A plurality of clutch center side boss portions 44 are provided at equal intervals in the circumferential direction of the clutch center 20. Here, three clutch center side boss portions 44 are provided, but the number of clutch center side boss portions 44 are not limited thereto. In FIG. 1, the clutch center side boss portion 44 extends to the side opposite to the disc portion 34 side of the clutch outer 18 of the clutch center 20.

The clutch center 20 also includes a stopper plate 46 attached to the distal end faces of the plurality of clutch center side boss portions 44. The stopper plate 46 is fixed to the clutch center side boss portion 44 by a bolt 48 inserted into the distal end face of the clutch center side boss portion 44.

The pressure plate 22 includes a disc-shaped plate portion 50, a plurality of tubular portions 52 extending in the axial direction of the clutch device 10 from the plate portion 50 toward the clutch center 20 side, and a pressurizing portion 54 formed on the outer peripheral portion of the plate portion 50 on the radially outer side of the tubular portion 52 and facing the pressure receiving portion 42. The tubular portion 52 corresponds to a clutch spring accommodating portion.

A tubular boss portion 55 defining a through-hole through which the main shaft 14 is inserted is provided at a central portion of the plate portion 50 of the pressure plate 22. As illustrated in FIG. 1, a bearing holding portion 55h is provided on the inner diameter side of the tubular boss portion 55, and a bearing 56 is provided therein. The bearing holding portion 55h provided so as to project out on the inner diameter side of the tubular boss portion 55 is positioned not on the clutch center 20 side in the pressure plate 22 but on the opposite side thereof.

The tubular portion 52 has a tubular accommodation space forming surface 52f. The accommodation space forming surface 52f defines and forms an accommodation space 52s for accommodating the clutch spring 26. Here, the accommodation space 52s is a hole. In the clutch device 10 of FIG. 1, a flange-shaped spring seat surface 52a extending radially inward of the tubular portion 52 is formed so as to bulge out into the accommodation space 52s at a distal end portion of the tubular portion 52 located on the clutch center 20 side of the pressure plate 22. The tubular portion 52 is further formed with a through-hole 52b axially penetrating the distal end of the tubular portion 52. The clutch spring 26 is disposed in the accommodation space 52s such that one end of the clutch spring 26 is in contact with the spring seat surface 52a.

The pressure plate 22 is assembled to the clutch center 20 in a state where each clutch center side boss portion 44 of the clutch center 20 is inserted into the through-hole 52b of each tubular portion 52. The pressure plate 22 is movable in the axial direction of the clutch device 10. Furthermore, the pressure plate 22 is relatively rotatable with respect to the clutch center 20 within a range where the clutch center side boss portion 44 is movable in the through-hole 52b.

The clutch spring 26 is a coil spring. In a state where the clutch center side boss portion 44 is inserted into the inner peripheral portion of the clutch spring 26, the clutch spring 26 is disposed, that is, accommodated in the accommodation space 52s. The clutch spring 26 is held by the clutch center 20 such that one end 26a abuts on the spring seat surface 52a of the pressure plate 22 and the other end 26b abuts on the stopper plate 46. Since the clutch device 10 is provided with three clutch center side boss portions 44, three clutch springs 26 are used. In the present disclosure, the number of clutch springs 26 is not limited, and may be one or more, but a plurality of clutch springs 26 can be preferably used.

The clutch plate 24, that is, the friction plate 24a and the clutch plate 24b are disposed in an annular space CS between the outer cylindrical portion 32 of the clutch outer 18 and the center cylindrical portion 40 of the clutch center 20, and are sandwiched between the pressure receiving portion 42 and the pressurizing portion 54. The friction plate 24a, which is a driving side clutch plate formed to a ring shape, has a plurality of outer peripheral protrusions formed on the outer peripheral edge thereof slidably engaged with a plurality of groove stripes formed in the circumferential direction directed in the axial direction on the inner peripheral surface of the outer cylindrical portion 32 of the clutch outer 18, and is movable in the axial direction of the clutch device 10 and rotates integrally with the clutch outer 18. The clutch plate 24b, which is a driven side clutch plate formed to a ring shape, has a plurality of inner peripheral protrusions formed on the inner peripheral edge thereof slidably engaged with a plurality of groove stripes formed in the circumferential direction directed in the axial direction on the outer peripheral surface of the center cylindrical portion 40 of the clutch center 20, and is movable in the axial direction of the clutch device 10 and rotates integrally with the clutch center 20. A plurality of friction plates 24a and a plurality of clutch plates 24b are alternately stacked in the axial direction.

The clutch spring 26 biases the pressure plate 22 in a direction in which the pressurizing portion 54 and the pressure receiving portion 42 crimp the clutch plate 24, that is, in a clutch connection direction. The state illustrated in FIG. 1 is the clutch connection state, and the clutch outer 18 and the clutch center 20 are connected by friction between the friction plate 24a and the clutch plate 24b when the clutch plate 24 is pressed in the axial direction by the biasing force of the clutch spring 26. In the clutch connection state, the clutch center 20 and the pressure plate 22 rotate integrally.

Specifically, in the clutch connection state, the driving force of the engine is transmitted to the input member 28, the clutch outer 18, the friction plate 24a, the clutch plate 24b, the clutch center 20, and the main shaft 14 in this order from the input side. Thereafter, the driving force of the engine is transmitted from the main shaft 14 to the rear wheels, which are driving wheels, through the counter shaft and the driving chain.

As illustrated in FIG. 1, the main shaft 14 is formed hollow, and a shaft hole 14h serving as an oil passage (axial oil passage) extending in the axial direction is defined and formed therein. When the engine is operated and the crankshaft 16 is rotated, a scavenging pump P, which is an oil pump, is driven, and the oil introduced into the shaft hole 14h of the main shaft 14 as illustrated in FIG. 1 is diverted, for example, to the branch holes 14hh radially branched from the shaft hole 14h, and is supplied to each shaft support portion of the plurality of transmission gears on the main shaft 14, and is also supplied to a needle bearing 28a, which is the shaft support portion of the input member 28, which is the primary driven gear that supports the clutch outer 18.

A clutch lifter member 60 is inserted into a distal end portion formed hollow on the clutch device 10 side of the main shaft 14 so as to be movable in the axial direction. As illustrated in FIG. 1, the clutch lifter member 60 is provided coaxially with the main shaft 14. That is, in the clutch device 10, the axis line 60x of the clutch lifter member 60 coincides with the axis line 10A of the clutch device 10. The insertion portion 60a of the clutch lifter member 60 described below has a plane extending in the axial direction so as not to rotate in the circumferential direction in the shaft hole 14h of the main shaft 14, and has a so-called D-shaped cross section. The shaft hole 14h of the main shaft 14 also has a shape that corresponds to the shape of the insertion portion 60a. However, the shape of the insertion portion 60a and the like is not limited thereto.

The clutch lifter member 60 is a rod-like member having a substantially columnar shape. The clutch lifter member 60 is also a hollow member having one end closed, and defines and forms the axial oil passage 60f therein. The clutch lifter member 60 includes an insertion portion 60a, a support portion 60b, and an engagement portion 60c lined in this order in the axial direction of the clutch device 10.

The insertion portion 60a is configured to be inserted into the axial oil passage of the main shaft 14, that is, the shaft hole 14h, and is particularly sized to slide along the inner wall surface of the shaft hole 14h. The support portion 60b is configured to support, that is, rotatably support the pressure plate 22 thereon. Here, the support portion 60b is a portion expanded in the radial direction from the insertion portion 60a, and when the insertion portion 60a is inserted into the main shaft 14, at least a part of the support portion 60b is configured to face the end face 14a of the main shaft 14. That is, the support portion 60b has a dimension that cannot be inserted into the shaft hole 14h of the main shaft 14, and can be referred to as a non-insertion portion. The support portion 60b is provided with a bearing holding portion 60e, and the bearing 56, described above, provided in the bearing holding portion 55h of the pressure plate 22 is fitted to the bearing holding portion 60e. Therefore, the clutch lifter member 60 is relatively rotatable with respect to the pressure plate 22 on the radially inner side of the pressure plate 22, and supports the pressure plate 22 through the bearing 56. The engagement portion 60c is configured such that an actuation rod 62 which is an actuation member engages thereto. Specifically, the engagement portion 60c includes a protruding portion 60d that protrudes out annularly and radially. The protruding portion 60d is provided at the distal end of the engagement portion 60c, that is, at the end portion on the side opposite to the support portion 60b in the engagement portion 60c. Note that the protruding portion 60d is not limited to the annular shape, and for example, may extend only in a part of the circumferential direction.

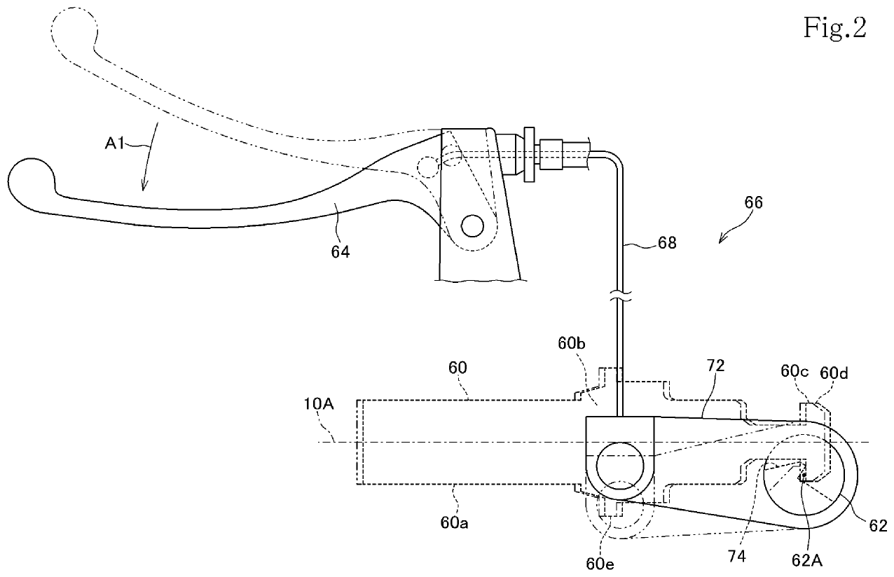

As shown in FIG. 2, a manual release mechanism 66 is actuated by the operation, in the direction of an arrow A1, on the clutch lever 64 by the driver, and the clutch lifter member 60 is moved in the axial direction of the main shaft 14. The manual release mechanism 66 includes a clutch cable 68 having one end connected to the clutch lever 64 and an arm member 72 connected with the other end of the clutch cable 68. One end of the actuation rod 62 described above is connected to the arm member 72. As illustrated in FIG. 2, when the clutch lever 64 is moved from the state of the two-dot broken line to the state of the solid line, the clutch cable 68 is pulled toward the clutch lever 64 side, whereby the arm member 72 rotates in a predetermined range corresponding to the movement of the clutch lever 64 around the central axis 62A of the actuation rod 62. The actuation rod 62 is provided with a claw portion 74 that can be engaged with the engagement portion 60c of the clutch lifter member 60. The claw portion 74 is configured to act on the engagement portion 60c according to the rotation of the actuation rod 62 caused by the movement of the clutch lever 64 in the disconnection direction, and move the clutch lifter member 60 in the direction of clutch disconnection in the axial direction. Therefore, the clutch lifter member 60 is moved in a direction away from the clutch center 20 in the axial direction by the actuation rod 62 which is an actuation member moved with the clutch disconnection. Note that, as is apparent from FIG. 1, the actuation rod 62 is provided at a predetermined position in the case member, here, the clutch case 13 so as to be substantially rotatable only about the axis line 62A.

When the clutch lifter member 60 is moved to the right side in FIG. 1 in the axial direction by the operation of the clutch lever 64, the pressure plate 22 is pressed via the bearing 56 that allows the relative rotation between the clutch lifter member 60 and the pressure plate 22. That is, when the pressure plate 22 is moved in the clutch disconnection direction (from the left side to the right side in the plane of drawing in FIG. 1) opposite to the clutch connection direction (from the right side to the left side in the plane of drawing in FIG. 1) against the biasing force of the clutch spring 26 with the movement of the clutch lifter member 60, the clutch device 10 enters the clutch disconnection state. In the clutch disconnection state, the pressing of the clutch plate 24 by the biasing force of the clutch spring 26 is released, and the driving force is not transmitted from the clutch outer 18 to the clutch center 20.

On the other hand, for example, when the driver releases his/her hand from the clutch lever 64, the clutch lever 64 returns to the position indicated by the two-dot broken line in FIG. 2, the pressure plate 22 is pressed toward the clutch center 20 side by the biasing force of the clutch spring 26, and the clutch device 10 enters the clutch connection state. At this time, the clutch lifter member 60, that is, the insertion portion 60a thereof advances into the shaft hole 14h of the main shaft 14 while moving the claw portion 74 of the actuation rod 62 and the arm member 72 in the clutch connection direction opposite to the clutch disconnection direction by the biasing force of the clutch spring 26.

The clutch device 10 includes a configuration of an assist and slipper clutch (A/S clutch), and specifically includes a cam mechanism 63 that converts the rotation difference of the relative rotation described above between the clutch center 20 and the pressure plate 22 into the movement of the clutch device 10 in the axial direction. The cam mechanism 63 includes a clutch center side cam portion 63a and a pressure plate side cam portion 63b. The plurality of clutch center side cam portions 63a are provided in the clutch center 20, and the plurality of pressure plate side cam portions 63b are provided in the pressure plate 22. The clutch center side cam portion 63a and the pressure plate side cam portion 63b are designed to be slidably combined with each other while facing each other.

In the clutch device 10 having the above configuration, the oil supply structure OS1 of the clutch device 10 includes an oil passage (hereinafter, the supply oil passage) 80 which is a further oil passage so as to more effectively supply oil to, for example, the clutch plate 24, that is, the friction plate 24a and the clutch plate 24b. As will be apparent from the following description, the supply oil passage 80 is formed such that the opening area thereof changes by the actuation of the actuation rod 62 accompanying the switching between the clutch connection and the clutch disconnection, that is, the clutch connection/disconnection. The oil supply structure OS1 includes an axial oil passage that is a shaft hole 14h of the main shaft 14h to which the oil from the pump P is supplied.

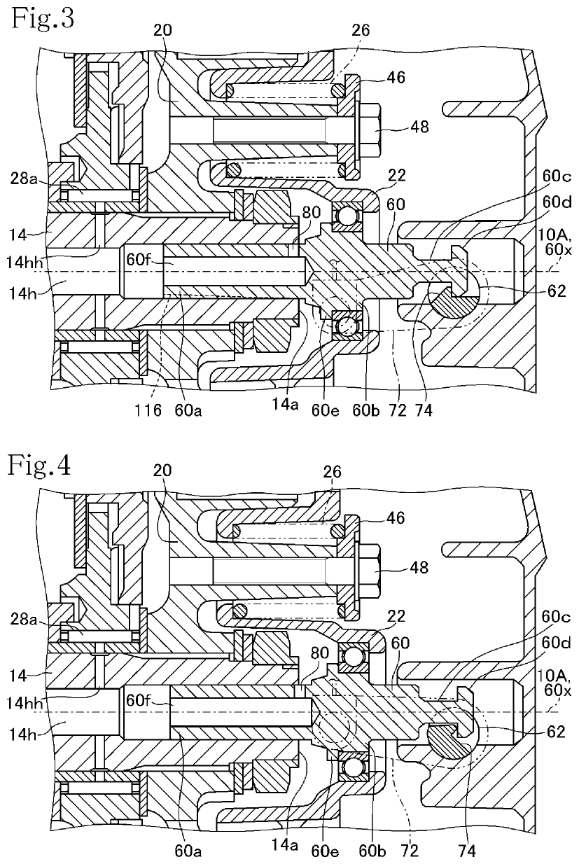

Here, an enlarged view of the periphery of the clutch lifter member 60 in FIG. 1 is shown in FIG. 3. FIG. 4 illustrates a state in which the clutch lifter member 60 is moved in the axial direction of the main shaft 14 at the time of clutch disconnection from the clutch connection state of FIG. 3. In FIGS. 3 and 4, the arm member 72 described above is indicated by a two-dot broken line in an overlapping manner.

In the clutch device 10, the supply oil passage 80 is formed in the clutch lifter member 60. As illustrated in FIGS. 1, 3, and 4, the clutch lifter member 60 is formed with an axial oil passage 60f that opens toward the insertion portion 60a side and closes on the engagement portion 60c side. When the insertion portion 60a of the clutch lifter member 60 is inserted into the main shaft 14, the axial oil passage 60f communicates with the shaft hole 14h, which is the axial oil passage, and thus can be filled with oil. Here, the axial oil passage 60f extends from end to end in the insertion portion 60a and extends to the support portion 60b in the clutch lifter member 60. The supply oil passage 80 is formed as a radial oil passage orthogonal to the direction of the axis line 60x of the clutch lifter member 60, that is, the axial direction, but is not limited thereto, and may be, for example, an oil passage extending diagonally in the axial direction. The supply oil passage 80 is formed such that one end opens on the outer peripheral surface of the clutch lifter member 60 and the other end communicates with the axial oil passage 60f of the clutch lifter member 60. The supply oil passage 80 is provided in the insertion portion 60a of the clutch lifter member 60, and particularly is provided in the vicinity of the support portion 60b in the insertion portion 60a here. Therefore, the supply oil passage 80 is located in the axial oil passage of the main shaft 14 at the time of clutch connection, that is, in the clutch connection state, and is covered and closed by the inner wall surface of the shaft hole 14h of the main shaft 14.

On the other hand, as shown in FIG. 4, as the clutch lifter member 60 moves in the axial direction at the time of clutch disconnection as described above, the supply oil passage 80 can exit from the shaft hole 14h of the main shaft 14.

Accordingly, the supply oil passage 80 opens. That is, the supply oil passage 80 is provided so as to open, that is, so that the opening area becomes larger at the time of clutch disconnection than at the time of clutch connection. In FIG. 4, the supply oil passage 80 is partially opened, but may be configured to be entirely opened at the time of clutch disconnection. The movable range of the clutch lever 64, the configuration of the manual release mechanism 66, the shape of the claw portion 74, and the like may be designed according to the amount of movement of the clutch lifter member 60 accompanying clutch connection/disconnection, the size and shape of the supply oil passage 80, the opening area of the supply oil passage 80 at the time of clutch disconnection, and the like. In FIG. 4, the supply oil passage 80 opens to a region or space between the clutch center 20 and the pressure plate 22.

The clutch device 10 having the above configuration is provided with the oil supply structure OS1 including the supply oil passage 80 in which the opening area changes by the movement of the clutch lifter member 60 accompanying the switching of the clutch connection/disconnection as described above. Therefore, the supply of oil to the clutch device 10 can be adjusted only according to the switching of the clutch connection/disconnection with a simpler configuration.

In particular, in the oil supply structure OS1 of the clutch device 10, the supply oil passage 80 is closed in the clutch connection state, and the supply oil passage 80 is opened with the clutch disconnection. Since the supply oil passage 80 is opened with the clutch disconnection, the oil can be suitably supplied to the clutch device 10. More specifically, while maintaining the oil supply amount necessary at the time of clutch connection, the supply amount of oil can be increased from the start to the release at the time of clutch disconnection. Therefore, for example, clutch disconnection of when the clutch is disconnected from the clutch connection state can be maintained in a suitable state, and wear toughness of the clutch can be more suitably enhanced.

The clutch lifter member 60 is not limited to the above configuration, and for example, the engagement portion 60c may be provided between the insertion portion 60a and the support portion 60b in the axial direction. The clutch lifter member 60 may not include the engagement portion 60c. In this case, the clutch lifter member 60 may be moved in the axial direction with the switching of the clutch connection/disconnection using a member or a mechanism other than the actuation rod 62. The same applies to the second embodiment described below.

Next, a clutch device 110 according to a second embodiment of the present invention will be described. Hereinafter, differences between the clutch device 110 and the clutch device 10 according to the first embodiment will be mainly described, and other configurations already described or configurations corresponding thereto will be similarly denoted with reference numerals already used, and redundant description thereof will be omitted.

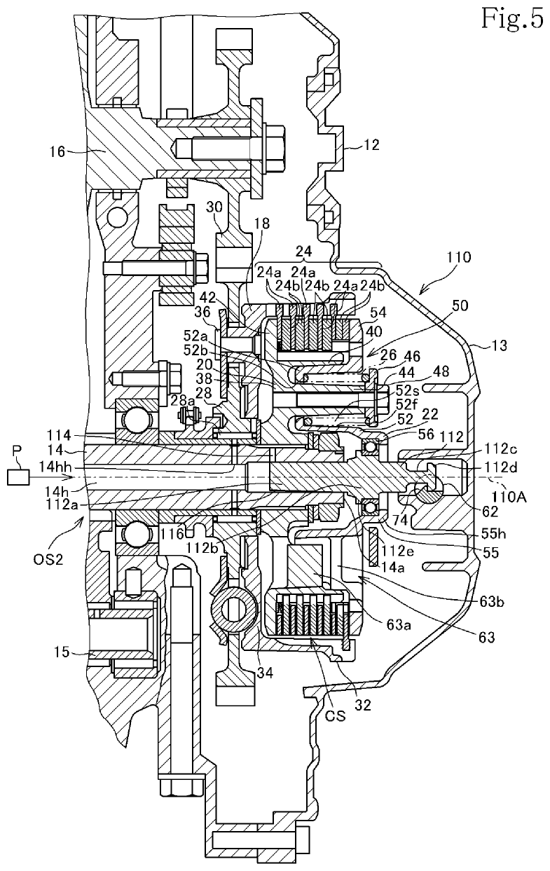

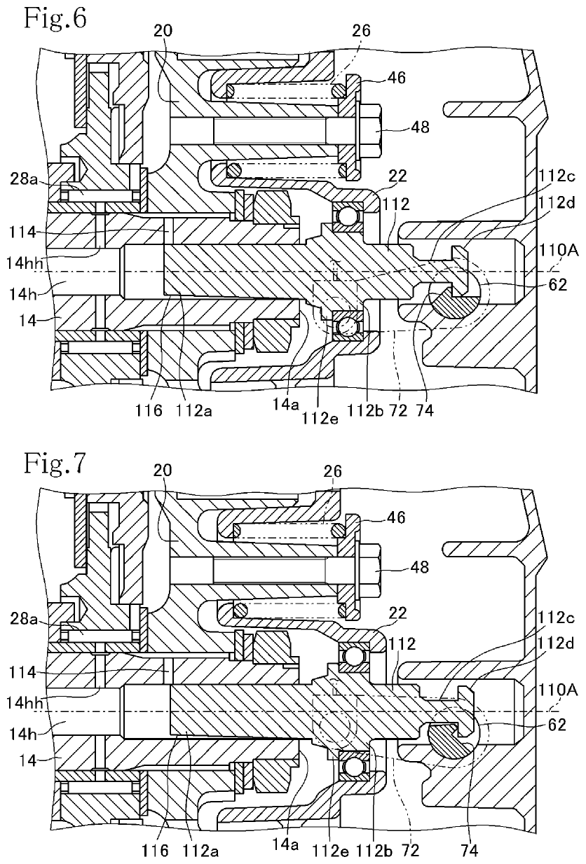

FIG. 5 shows a cross-sectional view of a clutch device 110 and a periphery thereof. FIG. 6 shows an enlarged view of the periphery of a clutch lifter member 112 of the clutch device 110 of FIG. 5, and FIG. 7 shows an enlarged view of the periphery of the clutch lifter member 112 at the time of clutch disconnection. Similarly to the clutch lifter member 60, the clutch lifter member 112 includes an insertion portion 112a, a support portion 112b having a bearing holding portion 112e, and an engagement portion 112c having a protruding portion 112d, but does not have a configuration corresponding to the axial oil passage 60f described above. The insertion portion 112a, the support portion 112b having the bearing holding portion 112e, and the engagement portion 112c having the protruding portion 112d correspond to the insertion portion 60a, the support portion 60b having the bearing holding portion 60e, and the engagement portion 60c having the protruding portion 60d, respectively.

In the oil supply structure OS2 of the clutch device 110 of the second embodiment, instead of the supply oil passage 80, the oil passage, that is, a supply oil passage 114 is provided in the main shaft 14 which is a shaft member. The supply oil passage 114 is located on the clutch lifter member 112 side than a branch hole 14hh. The supply oil passage 114 is located between the clutch outer 18, more specifically, its disc portion 34 and the pressure plate 22, more specifically, its plate portion 50 in the axial direction, and is particularly located radially inward of the clutch center 20 here. The supply oil passage 114 is a radial oil passage, and can communicate with the shaft hole 14h of the main shaft 14 extending in the direction of the axis line 110A of the clutch device 110, and is formed to open on the outer peripheral surface of the main shaft 14.

The supply oil passage 114 is provided such that the amount of communication with the shaft hole 14h of the shaft member 14, that is, the axial oil passage changes, that is, the opening area thereof changes by the insertion portion 112a of the clutch lifter member 112 moving through the shaft hole 14h of the shaft member 14. Specifically, as shown in FIGS. 5 and 6, the supply oil passage 114 is provided at a position substantially closed by the insertion portion 112a of the clutch lifter member 112, that is, the outer peripheral surface thereof in the clutch connection state, that is, at the time of clutch connection.

As described in the first embodiment, the supply oil passage 114 is located so as to be opened, that is, so that the opening area of the supply oil passage 114 increases by reducing the amount of insertion of the insertion portion 112a into the shaft hole 14h as the clutch lifter member 112 is moved in the axial direction at the time of clutch disconnection.

Therefore, according to the oil supply structure OS2 of the clutch device 110, since the supply oil passage 114 in which the opening area changes by the movement of the clutch lifter member 112 accompanying the switching of the clutch connection/disconnection is provided as described above, the oil supply to the clutch device 110 can be adjusted only according to the clutch operation with a simpler configuration.

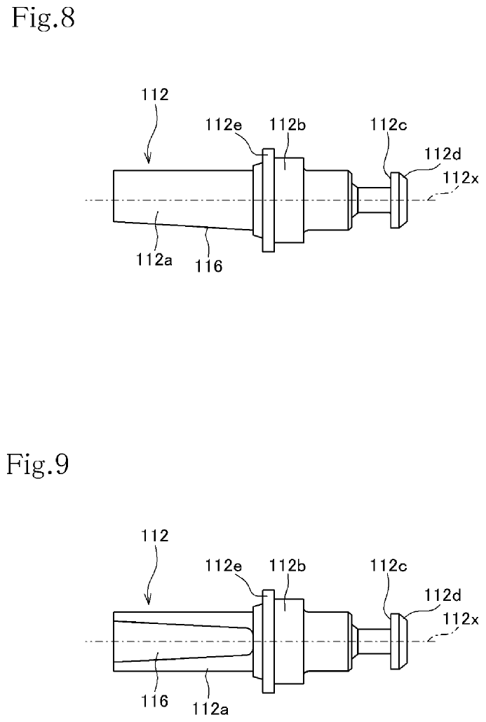

Here, FIG. 8 shows a front view of the clutch lifter member 112, that is, the clutch lifter member 112 in the same direction as the direction shown in FIG. 5, and FIG. 9 shows a bottom view of the clutch lifter member 112. In the clutch device 110, the clutch lifter member 112 includes an inclined portion 116 in addition to the insertion portion 112a, the support portion 112b having the bearing holding portion 112e, and the engagement portion 112c having the protruding portion 112d. The inclined portion 116 is provided in the insertion portion 112a, and is formed so as to approach the axis line 112x of the clutch lifter member 112 as it separates away from the support portion 112b. Here, the inclined portion 116 is a plane, and is configured such that the area of the inclined portion 116 increases at it separates away from the support portion 112b as illustrated in FIG. 9. However, the inclined portion 116 is not limited to a plane, and for example, may be a curved surface. The inclined portion 116 is formed in the clutch lifter member 112 by making the flat surface of the clutch lifter member 60 having the D-shaped cross section in the clutch device 10 of the first embodiment to an inclined surface.

The clutch lifter member 112 is disposed in the shaft hole 14h of the main shaft 14 of the clutch device 110 so that the inclined portion 116 does not overlap, that is, shift from the supply oil passage 114. As shown in FIGS. 5 to 7, a gap is formed between the outer surface of the insertion portion 112a of the clutch lifter member 112 and the inner wall surface of the shaft hole 14h of the main shaft 14 by providing the inclined portion 116. Thus, as compared with a case where the insertion portion 112a of the clutch lifter member 112 simply has a D-shaped cross section, the oil supplied to the main shaft 14 easily leaks into, and thus can be easily supplied to, the clutch device 110 from the outer surface of the insertion portion 112a of the clutch lifter member 112, particularly from between the inclined portion 116 and the shaft hole 14h of the main shaft 14. Therefore, even in the clutch connection state or the half clutch state illustrated in FIGS. 5 and 6, the oil can be more suitably supplied continuously into the clutch device 10. Thus, for example, the wear toughness of the clutch plate 24 in the half clutch state can be enhanced. On the other hand, the supply amount of oil in the clutch connection state or the half clutch state can be prevented from being excessive by providing the inclined portion 116.

The inclined portion 116 may be similarly applied to the clutch lifter member 60 of the clutch device 10 of the first embodiment. When the inclined portion 116 is applied to the clutch device 10, the inclined portion 116 may be provided on the clutch lifter member 60 shifted from the supply oil passage 80 so as not to overlap the supply oil passage 80 as indicated by a broken line in FIG. 3.

The clutch device may be configured to include both the supply oil passage 80 provided in the clutch lifter member 60 in the clutch device 10 of the first embodiment and the supply oil passage 114 provided in the main shaft 14 in the clutch device 110 of the second embodiment. At this time, for example, the supply oil passage 80 may be referred to as a first supply oil passage, and the supply oil passage 114 may be referred to as a second supply oil passage. At this time, the inclined portion 116 can also be provided in the clutch lifter member. At this time, the inclined portion 116 is preferably provided to be shifted from each of the supply oil passage 80 and the supply oil passage 114 as described above. The number of supply oil passages provided in the clutch lifter member is not limited to one, and may be plural. For example, when a plurality of supply oil passages 80 are provided in one clutch lifter member 60, the plurality of supply oil passages 80 may be shifted in the circumferential direction or may be shifted in the axial direction. Similarly, the number of supply oil passages provided in the main shaft 14 serving as a shaft member is not limited to one, and may be plural. For example, when a plurality of supply oil passages 114 are provided in the main shaft 14, the plurality of supply oil passages 114 may be shifted in the circumferential direction or may be shifted in the axial direction.

The embodiment of the present invention and the modified example thereof have been described above, but the present invention is not limited thereto. Various substitutions and changes may be made without departing from the spirit and scope of the present invention as defined by the claims of the present application.

The oil supply structure according to the present invention is not limited to being applied to the multi-plate clutch device having the above configuration, and can be applied to a clutch device having various configurations.

### REFERENCE SIGNS LIST

10, 110 Clutch device
14 Main shaft (shaft member)
16 Crankshaft
18 Clutch outer
20 Clutch center
22 Pressure plate
24a Friction plate
24b Clutch plate
26 Clutch spring
46 Stopper plate
60, 112 Clutch lifter member
80, 114 Supply oil passage
OS1, OS2 Oil supply structure

1. An oil supply structure of a clutch device comprising,
a clutch outer that is supported by a shaft member in a relatively rotatable manner;
a clutch center disposed on an inner side of the clutch outer and fixed to the shaft member;
a pressure plate facing the clutch center in an axial direction of the shaft member;
a friction plate and a clutch plate alternately fitted and inserted between the pressure plate and the clutch center;
a clutch spring that biases the pressure plate toward the clutch center side; and
a clutch lifter member provided on the pressure plate in a relatively rotatable manner in a radially inner side of the pressure plate;
the clutch lifter member including an insertion portion and a support portion lined in the axial direction, the insertion portion being configured to be inserted into an axial oil passage of the shaft member, the support portion being configured to support the pressure plate, and the clutch lifter member being configured to be moved in the axial direction with switching of clutch connection/disconnection; wherein
a supply oil passage in which an opening area changes by movement of the clutch lifter member in the axial direction accompanying the switching of clutch connection/disconnection is formed in at least one of the shaft member and the clutch lifter member.

2. The oil supply structure according to claim 1, wherein
the clutch lifter member includes the insertion portion, the support portion, and an engagement portion lined in the axial direction, the engagement portion being configured so as to be engaged by an actuation member; and
the clutch lifter member is provided so as to be moved in a direction away from the clutch center in the axial direction by the actuation member moved with clutch disconnection.

3. The oil supply structure according to claim 1, wherein
the supply oil passage is provided so that an opening area becomes larger when the clutch is disconnected than that when the clutch is connected.

4. The oil supply structure according to claim 1, wherein
the clutch lifter member includes an axial oil passage that opens toward the insertion portion side and closes on the engagement portion side, and
the supply oil passage communicates with the axial oil passage of the clutch lifter member and is provided in the insertion portion of the clutch lifter member.

5. The oil supply structure according to claim 1, wherein
the insertion portion of the clutch lifter member includes an inclined portion that approaches an axis line of the clutch lifter member as the insertion portion separates away from the support portion.

6. The oil supply structure according to claim 1, wherein
the supply oil passage is provided in the shaft member, and is provided such that amount of communication with the axial oil passage of the shaft member changes as the insertion portion of the clutch lifter member moves in the axial oil passage of the shaft member.

7. The oil supply structure according to claim 6, wherein
the insertion portion of the clutch lifter member includes an inclined portion that approaches an axis line of the clutch lifter member as the insertion portion moves away from the support portion, and
the clutch lifter member is disposed on the shaft member such that the inclined portion is shifted from the supply oil passage.

8. A clutch device comprising
the oil supply structure according to claim 1.
